(19) United States
(12) Patent Application Publication
(10) Pub. No.: US 2017/0169777 A1
(43) Pub. Date: Jun. 15, 2017

(54) OUTPUT CIRCUIT OF DISPLAY DRIVING DEVICE

(71) Applicant: SILICON WORKS CO., LTD., Daejeon-si (KR)

(72) Inventors: Young Bok KIM, Daejeon-si (KR); Hak Jin JUNG, Incheon-si (KR); Hyun Kyu JEON, Daejeon-si (KR); Joon Ho NA, Daejeon-si (KR)

(73) Assignee: SILICON WORKS CO., LTD., Daejeon-si (KR)

(21) Appl. No.: 15/378,316

(22) Filed: Dec. 14, 2016

(30) Foreign Application Priority Data
Dec. 14, 2015 (KR) 10-2015-0178520

(51) Int. Cl. G09G 3/36

(52) U.S. Cl. CPC G09G 3/3614; G09G 2300/0426; G09G 2300/0823; G09G 2310/08; G09G 2310/0291; G09G 2320/041; G09G 2310/06

(57) ABSTRACT

An output circuit of a display driving device may include: a first buffer including first and third output units driven in a range of a positive output signal included in an output voltage domain corresponding to a display panel; a second buffer including second and fourth output units driven in a range of a negative output signal included in the output voltage domain corresponding to the display panel; a first body control unit configured to control a body voltage of the first output unit and the second output unit; and a second body control unit configured to control a body voltage of the third output unit and the fourth output unit.

### BACKGROUND

1. Technical Field

The present disclosure relates to a display driving device, and more particularly, to an output circuit of a display driving device, which is capable of reducing heat generation.

2. Related Art

A liquid crystal display device is frequently used as a flat panel display device. The liquid crystal display device may display a screen using an optical shutter characteristic corresponding to the electrical environment of liquid crystal, and include a source driver, a gate driver and a timing controller in order to drive the liquid crystal.

A data signal with information for displaying a screen is transmitted to the source driver from the timing controller, and the source driver provides an output signal corresponding to the data signal to a display panel.

The display panel may include a liquid crystal display panel. When only data signals having the same polarity are provided, the liquid crystal display panel may have difficulties in forming a normal screen due to a liquid crystal driving error.

In order to overcome such difficulties, a polarity reversal technique may be employed.

According to the polarity reversal technique, the source driver can alternately provide positive and negative output signals to the same line of the liquid crystal display panel, thereby preventing sticking of liquid crystal.

Hereafter, the source driver is referred to as a display driving device. The display driving device is manufactured as one chip, and may include a digital block for processing a data signal and an output circuit for providing a signal converted by a digital-analog converter to the display panel.

In the related art, polarity reversal in the source driver is performed by an output switch installed between an output buffer and an output terminal for outputting an output signal to the display panel. However, when the output switch is switched for polarity reversal, the waveform of the output signal is delayed by an on-resistor of the output switch. Furthermore, the on-resistor of the output switch generates heat. Particularly, in the case of a display panel with a large load, the heat generation by the output switch further increases due to an increase of current consumption.

The above-described heat generation may have an influence on the operation of the source driver, and cause a problem when the display panel is driven. In order to solve such a problem, a method of reducing the resistance of the output switch may be suggested. In this case, however, the size of the resistor must be increased in order to reduce the resistance.

Furthermore, when the output buffer includes a plurality of output units in order to solve the above-described problem, a parasitic diode may be formed between a plurality of transistors formed on one substrate. In this case, the output buffer may not normally operate.

### SUMMARY

Various embodiments are directed to an output circuit of a display driving device, which is capable of minimizing waveform delay of an output signal provided to a display panel.

Also, various embodiments are directed to an output circuit of a display driving device, which is capable of reducing heat generation by an output signal while minimizing waveform delay of the output signal.

Also, various embodiments are directed to an output circuit of a display driving device, which is capable of preventing a formation of parasitic diode between transistors installed in output units of an output buffer, thereby smoothing the operation of the output buffer.

In an embodiment, an output circuit of a display driving device may include: a first buffer configured to provide a first input signal of an internal voltage domain as any one of first and second output signals to a display panel through a first internal switching operation corresponding to polarity reversal, and comprising a first output unit configured to provide the first output signal and a third output unit configured to provide the second output signal, wherein the first and third output units are driven in a range of a positive output signal included in an output voltage domain corresponding to the display panel; a second buffer configured to provide a second input signal of the internal voltage domain as the other one of the first and second output signals to the display panel through a second internal switching operation corresponding to the polarity reversal, and comprising a second output unit configured to provide the first output signal and a fourth output unit configured to provide the second output signal, wherein the second and fourth output units are driven in a range of a negative output signal included in the output voltage domain corresponding to the display panel; a first body control unit configured to control a body voltage of a pull-down driving element of the first output unit or a pull-up driving element of the second output unit; and a second body control unit configured to control a body voltage of a pull-down driving element of the third output unit or a pull-up driving element of the fourth output unit.

### BRIEF DESCRIPTION OF THE DRAWINGS

FIG. 1 is a block diagram illustrating an output circuit of a display driving device according to an embodiment of the present invention.

FIG. 2 is a detailed circuit diagram of the embodiment of FIG. 1.

FIG. 3 is a circuit diagram illustrating a state in which a control switch of FIG. 2 forms a signal transmission path different from FIG. 2.

FIG. 4 is a cross-sectional view of MOS transistors constituting first and second output units of FIG. 3.

FIG. 5 is a block diagram illustrating a part of an output circuit of a display driving device according to another embodiment of the present invention.

FIG. 6 is a circuit diagram illustrating the other part of the output circuit of the display driving device according to the embodiment of the present invention.

FIG. 7 is a circuit diagram illustrating a state in which a signal transmission path different from FIG. 5 is formed.

FIG. 8 is a circuit diagram illustrating a state in which a signal transmission path different from FIG. 7 is formed.

### DETAILED DESCRIPTION

Hereafter, embodiments of the present invention will be described in detail with reference to the accompanying drawings. The terms used in the present specification and claims are not limited to typical dictionary definitions, but must be interpreted into meanings and concepts which coincide with the technical idea of the present invention.

Embodiments described in the present specification and configurations illustrated in the drawings are preferred embodiments of the present invention, and do not represent the entire technical idea of the present invention. Thus, various equivalents and modifications capable of replacing the embodiments and configurations may be provided at the point of time that the present application is filed.

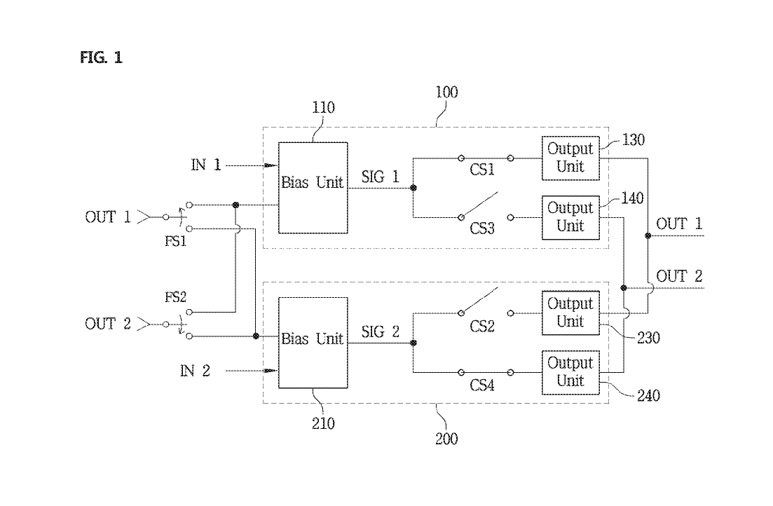

FIG. 1 is a block diagram illustrating an output circuit of a display driving device according to an embodiment of the present invention.

The output circuit of the display driving device in FIG. 1 has two input signals IN1 and IN2 and two output signals OUT1 and OUT2.

The input signals IN1 and IN2 of the output circuit of the display driving device in FIG. 1 are analog signals having a level corresponding to the gray value of data, and may be provided from an analog-digital converter. Thus, a voltage domain applied to an output terminal of the analog-digital converter is applied to the input signals IN1 and IN2. The voltage domain is referred to as an internal voltage domain.

The output circuit of the display driving device uses voltages in a different domain from the internal voltage domain, in order to perform buffering, switching and output operations corresponding to the input signals IN1 and IN2.

More specifically, the two output signals OUT1 and OUT2 of the display driving device are directly provided to the display panel. Therefore, the two output signals OUT1 and OUT2 use an output voltage domain required by the display panel. The output voltage domain, which is wider than the internal voltage domain, may be applied to buffering, switching and output operations in the output circuit of the display driving device. Thus, the two output signals OUT1 and OUT2 may be defined as levels belonging to the output voltage domain.

Referring to FIG. 1, the output circuit of the display driving device according to the present embodiment includes buffers 100 and 200 configured to output any one of the two output signals OUT1 and OUT2 in response to one input signal.

An image displayed on a display panel is implemented by consecutive frames. When first and second frames are consecutively and sequentially displayed and a polarity reversal is performed on a frame basis, the output signals OUT1 and OUT2 of the first and second frames corresponding to the input signals IN1 and IN2 are changed by the polarity reversal. At the first frame, the output signal OUT1 may correspond to the input signal IN1, and the output signal OUT2 may correspond to the input signal IN2. In this case, at the second frame, the output signal OUT2 may correspond to the input signal IN1, and the output signal OUT1 may correspond to the input signal IN2.

The configurations of the buffers 100 and 200 for the above-described operation will be described as follows.

The buffer 100 includes a bias unit 110, control switches CS1 and CS3 and output units 130 and 140, and the buffer 200 includes a bias unit 210, control switches CS2 and CS4 and output units 230 and 240.

The buffer 100 selectively provides the output signal OUT1 or OUT2 to the display panel (not illustrated) in response to the analog input signal IN1 outputted from a digital-analog converter (not illustrated). The buffer 200 selectively provides the output signal OUT1 or OUT2 to the display panel (not illustrated) in response to the analog input signal IN2 outputted from another digital-analog converter (not illustrated).

When the output signal OUT1 is provided by the buffer 100, the output signal OUT2 is provided by the buffer 200. On the other hand, when the output signal OUT1 is provided by the buffer 200, the output signal OUT2 is provided by the buffer 100. The output signals OUT1 and OUT2 may indicate signals outputted through two output terminals of the display driving device (source driver), and the buffers 100 and 200 may be configured to selectively provide output signals to the two output terminals, respectively, without an overlap therebetween.

The output signal OUT1 and the output signal OUT2 may be divided into a positive signal and a negative signal, based on a third voltage Vmid described later. More specifically, when the output signal OUT1 and the output signal OUT2 are higher than the third voltage Vmid, the output signals may be defined as positive signals, and when the output signal OUT1 and the output signal OUT2 are lower than the third voltage Vmid, the output signals may be defined as negative signals. The output signal OUT1 and the output signal OUT2 have different polarities from each other.

The bias unit 110 receives the input signal IN1 and outputs a driving signal SIG1, and the bias unit 210 receives the input signal IN2 and outputs a driving signal SIG2. The bias units 110 and 210 change an input signal into a signal in a preset voltage scale, that is, the output voltage domain.

When the buffer 100 outputs the output signal OUT1, the bias unit 110 outputs the driving signal SIG1 corresponding to the input signal IN1 using the fed-back output signal OUT1, and when the buffer 100 outputs the output signal OUT2, the bias unit 110 outputs the driving signal SIG1 corresponding to the input signal IN1 using the fed-back output signal OUT2.

When the buffer 200 outputs the output signal OUT1, the bias unit 210 outputs the driving signal SIG2 corresponding to the input signal IN2 using the fed-back output signal OUT1, and when the buffer 200 outputs the output signal OUT2, the bias unit 210 outputs the driving signal SIG2 corresponding to the input signal IN2 using the fed-back output signal OUT2.

The driving signal SIG1 is provided to the output unit 130 or 140 through the control switch CS1 or CS3, and the driving signal SIG2 is provided to the output unit 230 or 240 through the control switch CS2 or CS4.

The output unit 130 provides the output signal OUT1 in response to the driving signal SIG1, and the output unit 140 provides the output signal OUT2 in response to the driving signal SIG1. The output unit 230 provides the output signal OUT1 in response to the driving signal SIG2, and the output unit 240 provides the output signal OUT2 in response to the driving signal SIG2.

The control switches CS1 to CS4 form signal transmission paths of the driving signals SIG1 and SIG2 provided from the bias units 110 and 210 in the buffers 100 and 200.

More specifically, the signal transmission path may include a direct path or cross path formed by the control switches CS1 to CS4. The direct path is a path through which the driving signal SIG1 of the bias unit 110 is transmitted to the output unit 130 via the control switch CS1, and the driving signal SIG2 of the bias unit 210 is transmitted to the output unit 240 via the control switch CS4. The cross path is a path through which the driving signal SIG1 of the bias unit 110 is transmitted to the output unit 140 via the control switch CS3, and the driving signal SIG2 of the bias unit 210 is transmitted to the output unit 230 via the control switch CS2.

That is, the control switches CS1 to CS4 selectively form a direct path or cross path, the direct path is formed by the control switches CS1 and CS4 which are turned on, and the cross path is formed by the control switches CS2 and CS3 which are turned on.

FIG. 1 exemplifies the case in which the control switches CS1 to CS4 form a direct path. More specifically, the bias unit 110 selects the fed-back output signal OUT1 to output the driving signal SIG1, the bias unit 210 selects the fed-back output signal OUT2 to output the driving signal SIG2, the bias unit 110 and the output unit 130 are connected to each other by the turned-on control switch CS1, and the bias unit 210 and the output unit 240 are connected to each other by the turned-on control switch CS4.

The control switches CS1 to CS4 may form a direct path or cross path in response to a polarity reversal signal (not illustrated) provided from outside. Through the switching operations of the control switches CS1 to CS4, the display panel receives the output signals OUT1 and OUT2 of which the polarities are repetitively reversed between the positive and negative polarities.

The buffer 100 may further include a first feedback switch FS1 configured to feed back any one of the output signals OUT1 and OUT2 to the bias unit 110, and the buffer 200 may further include a second feedback switch FS2 configured to feed back any one of the output signals OUT1 and OUT2 to the bias unit 210.

The output of the buffer 100, which is fed back by the first or second feedback switch FS1 or FS2, is used for differential amplification of the bias unit 110, and the bias unit 110 uses the fed-back output of the buffer 100 as a reference voltage, and performs a differential amplification operation of comparing the reference voltage to the input signal IN1 and amplifying a difference therebetween.

The output of the buffer 200, which is fed back by the first or second feedback switch FS1 or FS2, is used for differential amplification of the bias unit 210, and the bias unit 210 uses the fed-back output of the buffer 200 as a reference voltage, and performs a differential amplification operation of comparing the reference voltage to the input signal IN2 and amplifying a difference therebetween.

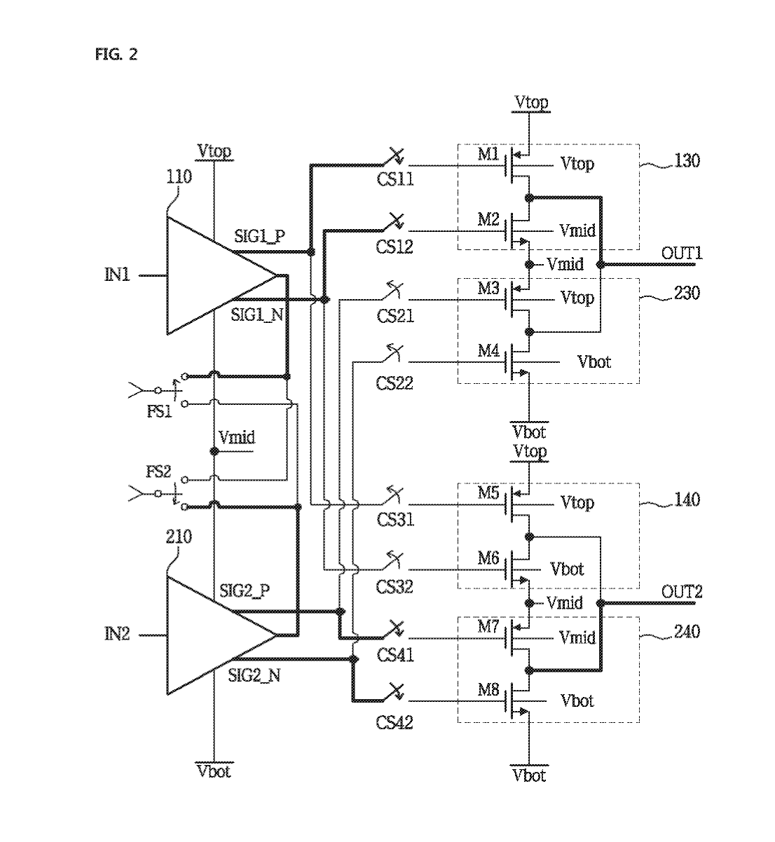

FIG. 2 is a detailed circuit diagram of the embodiment of FIG. 1, exemplifying the case in which a signal is transmitted through a direct path.

FIG. 2 illustrates the voltage terminals of the bias units 110 and 210 and the output units 130, 230, 140 and 240 and the voltage environment therearound. In FIG. 2, a voltage Vtop is the highest voltage among voltages Vtop, Vmid and Vbot and referred to as a first voltage, the voltage Vbot is the lowest voltage among the voltages Vtop, Vmid and Vbot and referred to as a second voltage, and the voltage Vmid is a voltage having a level between the first voltage Vtop and the second voltage Vbot and referred to as a third voltage. The third voltage Vmid may be set to an average of the first and second voltages Vtop and Vbot. For example, when the first voltage Vtop is 10V and the second voltage Vbot is 0V, the third voltage Vmid may be set to 5V. Furthermore, when the first voltage Vtop is 5V and the second voltage Vbot is −5V, the third voltage Vmid may be set to 0V.

The buffers 100 and 200 may be operated in the output voltage domain wider than the internal voltage domain, that is, a full voltage range of PVDD to NVDD or PVDD to GND which is provided to the display panel. In the present embodiment, the output voltage domain may be defined by the highest first voltage Vtop, the lowest second voltage Vbot, the third voltage Vmid having a level between the first voltage Vtop and the second voltage Vbot.

Thus, the first and second output signals OUT1 and OUT2 may have a level in a range of positive output signals between the first voltage Vtop and the third voltage Vmid or a range of negative output signals between the second voltage Vbot and the third voltage Vmid.

More specifically, the buffer 100 may include a first voltage (Vtop) terminal and a third voltage (Vmid) terminal, and be driven in the range of the first voltage Vtop to the third voltage Vmid. The buffer 200 may include the third voltage (Vmid) terminal and a second voltage (Vbot) terminal, and be driven in the range of the third voltage Vmid to the second voltage Vbot.

At this time, the bias unit 110 outputs the driving signal SIG1 in the range of the first voltage Vtop to the third voltage Vmid, and the bias unit 210 outputs the driving signal SIG2 in the range of the third voltage Vmid to the second voltage Vbot. The bias unit 110 and the bias unit 210 may share the third voltage (Vmid) terminal.

The output unit 130 and the output unit 140 include a first voltage (Vtop) terminal and a third voltage (Vmid) terminal, respectively, and output the output signal OUT1 or OUT2 in the range of the first voltage Vtop to the third voltage Vmid. The output unit 230 and the output unit 240 include a third voltage (Vmid) terminal and a second voltage (Vbot) terminal, respectively, and output the output signal OUT1 or OUT2 in the range of the third voltage Vmid to the second voltage Vbot.

The output units 130 and 230 are configured to share the third voltage (Vmid) terminal, and the output units 140 and 240 are configured to share the third voltage (Vmid) terminal.

The driving signal SIG1 provided by the bias unit 110 includes two driving signals SIG1_P and SIG1_N having a complementary relation therebetween. The driving signal SIG1_P is provided to PMOS transistors M1 and M5 of the output units 130 and 140 from the bias unit 110, and has a range of the first voltage Vtop to the third voltage Vmid. The driving signal SIG1_N is provided to NMOS transistors M2 and M6 of the output units 130 and 140 from the bias unit 110, and has a range of the first voltage Vtop to the third voltage Vmid. The driving signals SIG1_P and SIG1_N may be provided to any one of the output units 130 and 140 in response to a source output enable (SOE) signal (not illustrated) provided from outside, depending on the switching states of the control switches CS1 and CS3.

The driving signal SIG2 provided by the bias unit 210 includes two driving signals SIG2_P and SIG2_N having a complementary relation therebetween. The driving signal SIG2_P is provided to PMOS transistors M3 and M7 of the output units 230 and 240 from the bias unit 210, and has a range of the third voltage Vmid to the second voltage Vbot. The driving signal SIG2_N is provided to NMOS transistors M4 and M8 of the output units 230 and 240 from the bias unit 210, and has a range of the third voltage Vmid to the second voltage Vbot. The driving signals SIG2_P and SIG2_N may be provided to any one of the output units 230 and 240 in response to the SOE signal (not illustrated) provided from outside, depending on the switching states of the control switches CS2 and CS4.

The control switch CS1 includes a pair of control switches CS11 and CS12 configured to transmit two driving signals SIG1_P and SIG1_N, the control switch CS11 is switched to transmit the driving signal SIG1_P to the gate of the PMOS transistor M1 of the output unit 130, and the control switch CS12 is switched to transmit the driving signal SIG1_N to the NMOS transistor M2 of the output unit 130. The turn on/off of the pair of control switches CS11 and CS12 may be decided in the same way.

The control switch CS3 includes a pair of control switches CS31 and CS32 configured to transmit two driving signals SIG1_P and SIG1_N, the control switch CS31 is switched to transmit the driving signal SIG1_P to the gate of the PMOS transistor M5 of the output unit 140, and the control switch CS32 is switched to transmit the driving signal SIG1_N to the NMOS transistor M6 of the output unit 140. The turn on/off of the pair of control switches CS31 and CS32 may be decided in the same way.

The control switch CS2 includes a pair of control switches CS21 and CS22 configured to transmit two driving signals SIG2_P and SIG2_N, the control switch CS21 is switched to transmit the driving signal SIG2_P to the gate of the PMOS transistor M3 of the output unit 230, and the control switch CS22 is switched to transmit the driving signal SIG2_N to the NMOS transistor M4 of the output unit 230. The turn on/off of the pair of control switches CS21 and CS22 may be decided in the same way.

The control switch CS4 includes a pair of control switches CS41 and CS42 configured to transmit two driving signals SIG2_P and SIG2_N, the control switch CS41 is switched to transmit the driving signal SIG2_P to the gate of the PMOS transistor M7 of the output unit 240, and the control switch CS42 is switched to transmit the driving signal SIG2_N to the NMOS transistor M8 of the output unit 240. The turn on/off of the pair of control switches CS41 and CS42 may be decided in the same way.

The turn-on/off of the control switch CS1 may indicate the turn-on/off of the control switches CS11 and CS12, the turn-on/off of the control switch CS2 may indicate the turn-off of the control switches CS21 and CS22, the turn-on/off of the control switch CS3 may indicate the turn-on/off of the control switches CS31 and CS32, and the turn-on/off of the control switch CS4 may indicate the turn-off of the control switches CS41 and CS42.

The control switches CS1 and CS4 are turned on to form a direct path. More specifically, the control switch CS1 is turned on to transmit the driving signals SIG1_P and SIG1_N provided from the bias unit 110 to the output unit 130, and the control switch CS4 is turned on to transmit the driving signals SIG2_P and SIG2_N provided from the bias unit 210 to the output unit 240.

The control switches CS2 and CS3 are turned on to form a cross path. The control switch CS3 transmits the driving signals SIG1_P and SIG1_N provided from the bias unit 110 to the output unit 230, and the control switch CS2 transmits the driving signals SIG2_P and SIG2_N provided from the bias unit 210 to the output unit 140.

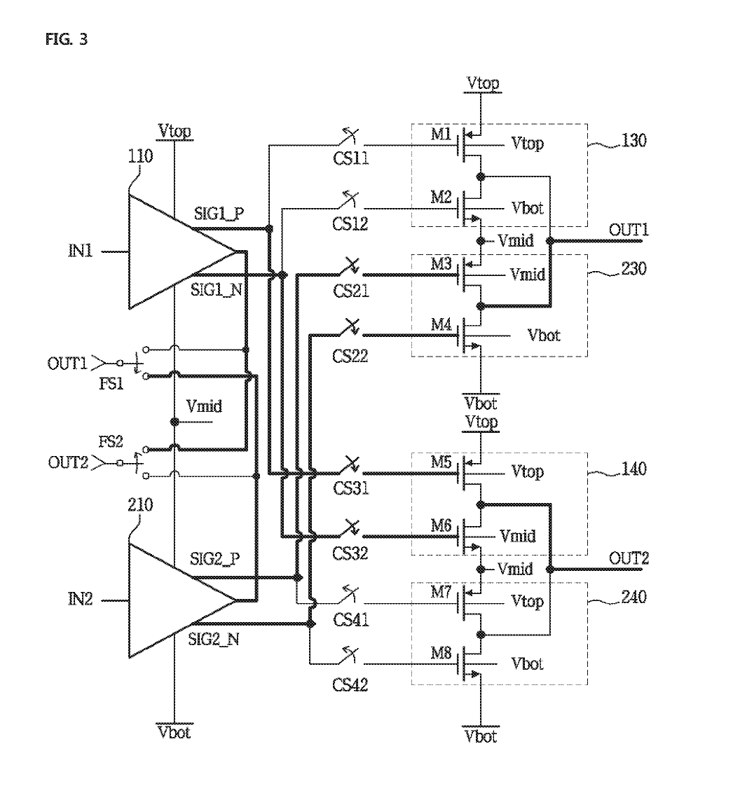

FIG. 2 is a circuit diagram exemplifying that a direct path is formed, and FIG. 3 is a circuit diagram exemplifying that a cross path is formed. When a polarity reversal is performed on a frame basis, the direct path illustrated in FIG. 2 may be formed in response to a first frame, and the cross path illustrated in FIG. 3 may be formed in response to a second frame. While the control switches CS1 and CS4 and the control switches CS2 and CS3 are alternately turned on/off according to a polarity reversal signal, the direct path of FIG. 2 and the cross path of FIG. 3 are alternately formed.

Referring to FIGS. 2 and 3, the output unit 130 and the output unit 230 are formed on one substrate, and share the third voltage (Vmid) terminal and the output terminal for outputting the output signal OUT1. The output unit 140 and the output unit 240 are also formed on one substrate, and share the third voltage (Vmid) terminal and the output terminal for outputting the output signal OUT2.

Each of the output units 130, 140, 230 and 240 outputs the output signal OUT1 or OUT2 to the display panel (not illustrated) when the driving signals SIG1_P and SIG1_N or the driving signals SIG2_P and SIG2_N are applied to the gate thereof. In the present embodiment, the first voltage Vtop may be used as a pull-up voltage of the output units 130 and 140, and the third voltage Vmid may be used as a pull-down voltage of the output units 130 and 140. Furthermore, the third voltage Vmid may be used as a pull-up voltage of the output units 230 and 240, and the second voltage Vbot may be used as a pull-down voltage of the output units 230 and 240.

The output unit 130 may share the third voltage (Vmid) terminal with the output unit 230, and the output unit 140 may share the third voltage (Vmid) terminal with the output unit 240.

Each of the output units 130, 140, 230 and 240 includes one or more PMOS transistors and one or more NMOS transistors in order to output the output signal OUT1 or OUT2 in a predetermined voltage range.

The output unit 130 includes the PMOS transistor M1 and the NMOS transistor M2 which are coupled through a common drain structure. The PMOS transistor M1 has the source connected to the first voltage (Vtop) terminal, and receives the driving signal SIG1_P through the gate thereof. The first voltage Vtop is applied to the body of PMOS transistor M1. The NMOS transistor M2 has the source connected to the third voltage (Vmid) terminal, and receives the driving signal SIG1_N through the gate thereof. When the direct path is formed as illustrated in FIG. 2, the third voltage Vmid is applied to the body of the NMOS transistor M2, and when the cross path is formed as illustrated in FIG. 3, the second voltage Vbot is applied to the body of the NMOS transistor M2.

When the control switches CS1 to CS4 form a direct path, the driving signals SIG1_P and SIG1_N provided from the bias unit 110 are provided to the output unit 130 to drive the PMOS transistor M1 and the NMOS transistor M2. According to the magnitudes of the driving signals SIG1_P and SIG1_N, the level of the output signal OUT1 outputted from the bias unit 110 is decided.

The output unit 230 includes the PMOS transistor M3 and the NMOS transistor M4 which are coupled through a common drain structure. The PMOS transistor M3 has the source connected to the third voltage (Vmid) terminal, and receives the driving signal SIG2_P through the gate thereof. When the direct path is formed as illustrated in FIG. 2, the first voltage Vtop is applied to the body of the PMOS transistor M3, and when the cross path is formed as illustrated in FIG. 3, the third voltage Vmid is applied to the body of the PMOS transistor M3. The NMOS transistor M4 has the source connected to the second voltage (Vbot) terminal, and receives the driving signal SIG2_N through the gate thereof. The second voltage Vbot is applied to the body of the NMOS transistor M4.

When the control switches CS1 to CS4 form a cross path, the driving signals SIG2_P and SIG2_N provided from the bias unit 210 are provided to the output unit 230 to drive the PMOS transistor M3 and the NMOS transistor M4. According to the magnitudes of the driving signals SIG2_P and SIG2_N, the level of the output signal OUT1 outputted from the bias unit 210 is decided.

The output unit 140 includes the PMOS transistor M5 and the NMOS transistor M6 which are coupled through a common drain structure. The PMOS transistor M5 has the source connected to the first voltage (Vtop) terminal, and receives the driving signal SIG1_P through the gate thereof. The first voltage Vtop is applied to the body of the PMOS transistor M5. The NMOS transistor M6 has the source connected to the third voltage (Vmid) terminal, and receives the driving signal SIG1_N through the gate thereof. When the direct path is formed as illustrated in FIG. 2, the second voltage Vbot is applied to the body of the NMOS transistor M6, and when the cross path is formed as illustrated in FIG. 3, the third voltage Vmid is applied to the body of the NMOS transistor M6.

When the control switches CS1 to CS4 form a cross path, the driving signals SIG1_P and SIG1_N provided from the bias unit 110 are provided to the output unit 140 to drive the PMOS transistor M5 and the NMOS transistor M6. According to the magnitudes of the driving signals SIG1_P and SIG1_N, the level of the output signal OUT2 outputted from the bias unit 110 is decided.

The output unit 240 includes the PMOS transistor M7 and the NMOS transistor M8 which are coupled through a common drain structure. The PMOS transistor M7 has the source connected to the third voltage (Vmid) terminal, and receives the driving signal SIG2_P through the gate thereof. When the direct path is formed as illustrated in FIG. 2, the third voltage Vmid is applied to the body of the PMOS transistor M7, and when the cross path is formed as illustrated in FIG. 3, the first voltage Vtop is applied to the body of the PMOS transistor M7. The NMOS transistor M8 has the source connected to the second voltage (Vbot) terminal, and receives the driving signal SIG2_N through the gate thereof. The second voltage Vbot is applied to the body of the NMOS transistor M8.

When the control switches CS1 to CS4 form a direct path, the driving signals SIG2_P and SIG2_N provided from the bias unit 210 are provided to the output unit 240 to drive the PMOS transistor M7 and the NMOS transistor M8. According to the magnitudes of the driving signals SIG2_P and SIG2_N, the level of the output signal OUT2 outputted from the bias unit 210 is decided.

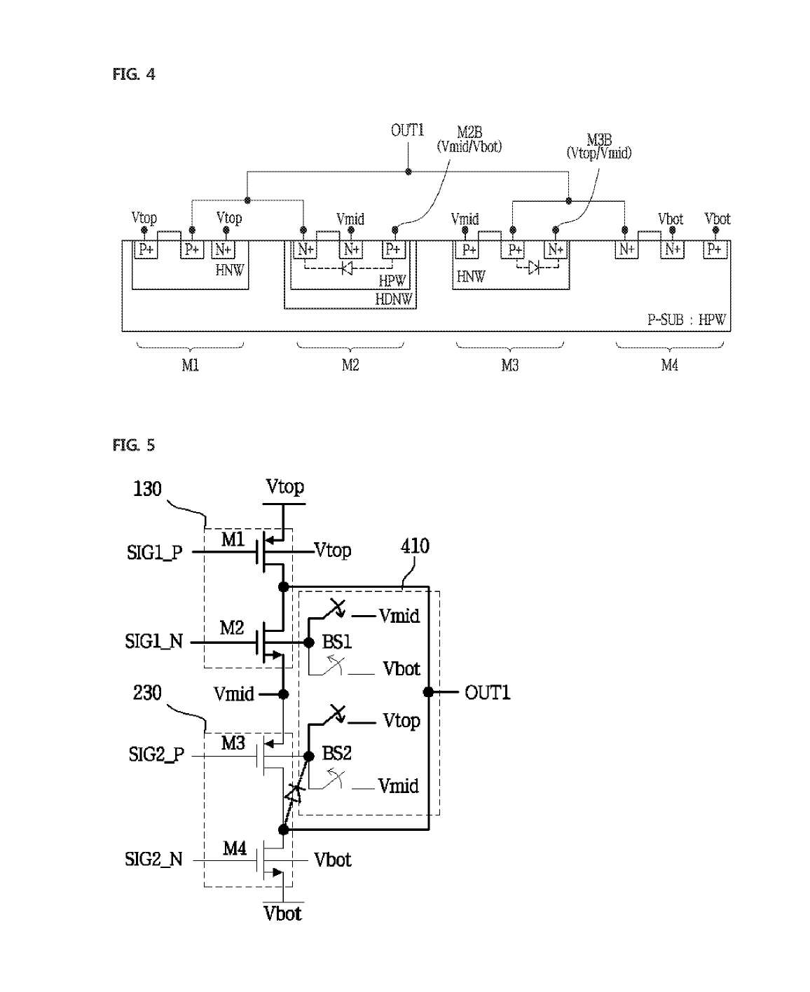

When a direct path or cross path is formed, the body voltages of the MOS transistors included in the output units 130, 140, 230 and 240 may be partially changed. This will be described with reference to FIG. 4.

FIG. 4 is a cross-sectional view of a substrate P-SUB in which MOS transistors M1 to M4 constituting the output units 130 and 230 are formed.

Referring to FIG. 4, four MOS transistors M1 to M4 are formed in the P-type substrate P-SUB, the PMOS transistors M1 and M3 are formed in an N-well HNW, and the NMOS transistor M2 is formed in a P-well HPW. The P-well HPW for forming the NMOS transistor M2 is electrically separated from the P-type substrate P-SUB by a deep N-well HDNW. The NMOS transistor M4 is formed on the P-type substrate P-SUB.

In the NMOS transistor, a back bias voltage applied to the P-type body needs to be equal to or lower than a voltage applied to the N-type source and drain terminals, in order to prevent a formation of parasitic diode between the body and the source and drain terminals and a current leakage by the parasitic diode. In the PMOS transistor, however, a back bias voltage applied to the N-type body needs to be equal to or higher than a voltage applied to the P-type source and drain terminals.

Therefore, along a path formed by the control switches CS1 to CS4, the body voltages of the MOS transistors constituting the output units 130, 140, 230 and 240 need to be changed.

When the driving signals SIG1_P and SIG1_N are provided to the output unit 130 in response to a direct path of the control switches CS1 to CS4, the PMOS transistor M1 and the NMOS transistor M2 are driven, and a voltage having a voltage range of the first voltage Vtop to the third voltage Vmid is applied to the output terminal of the output unit 130.

At this time, the PMOS transistor M3 and the NMOS transistor M4, which are included in the output unit 230, are not driven in response to the direct path of the control switches CS1 to CS4. However, since the output units 130 and 230 share the output terminal, the voltage of the output signal OUT1 outputted through the output unit 130 is also applied to the PMOS transistor M3 of the output unit 230. Therefore, a parasitic diode may be formed due to a voltage difference between the drain terminal and the body M3B of the PMOS transistor M3 which is not driven. Thus, in order to prevent a formation of parasitic diode, the highest first voltage Vtop needs to be applied to the body M3B of the PMOS transistor M3 in response to the direct path of the control switches CS1 to CS4.

In the PMOS transistor M1 and the NMOS transistor M2 which are driven in response to the direct path of the control switches CS1 to CS4, a voltage such as the third voltage Vmid of the source terminal of the NMOS transistor M2 may be applied to the body M2B of the NMOS transistor M2, such that a driving signal is smoothly outputted.

When the driving signals SIG2_P and SIG2_N are provided to the output unit 230 in response to a cross path of the control switches CS1 to CS4, the PMOS transistor M3 or the NMOS transistor M4 is driven, and a voltage having a voltage range of the third voltage Vmid to the second voltage Vbot is applied to the output terminal of the output unit 230.

At this time, the PMOS transistor M1 and the NMOS transistor M2, which are included in the output unit 130, are not driven in response to the cross path of the control switches CS1 to CS4. However, since the output units 130 and 230 share the output terminal, the voltage of the output signal OUT1 outputted through the output unit 230 is also applied to the NMOS transistor M2 of the output unit 130. Therefore, a parasitic diode may be formed due to a voltage difference between the drain terminal and the body M2B of the NMOS transistor M2 which is not driven. Thus, in order to prevent a formation of parasitic diode, the lowest second voltage Vbot needs to be applied to the body M2B of the NMOS transistor M2 in response to the cross path of the control switches CS1 to CS4.

In the PMOS transistor M3 and the NMOS transistor M4 which are driven in response to the cross path of the control switches CS1 to CS4, a voltage such as the third voltage Vmid of the source terminal of the PMOS transistor M3 may be applied to the body M3B of the PMOS transistor M3, such that a driving signal is smoothly outputted.

The change in body voltages of the MOS transistors in response to the direct path or cross path of the control switches CS1 to CS4 may also be applied to the output units 140 and 240 for the same reason.

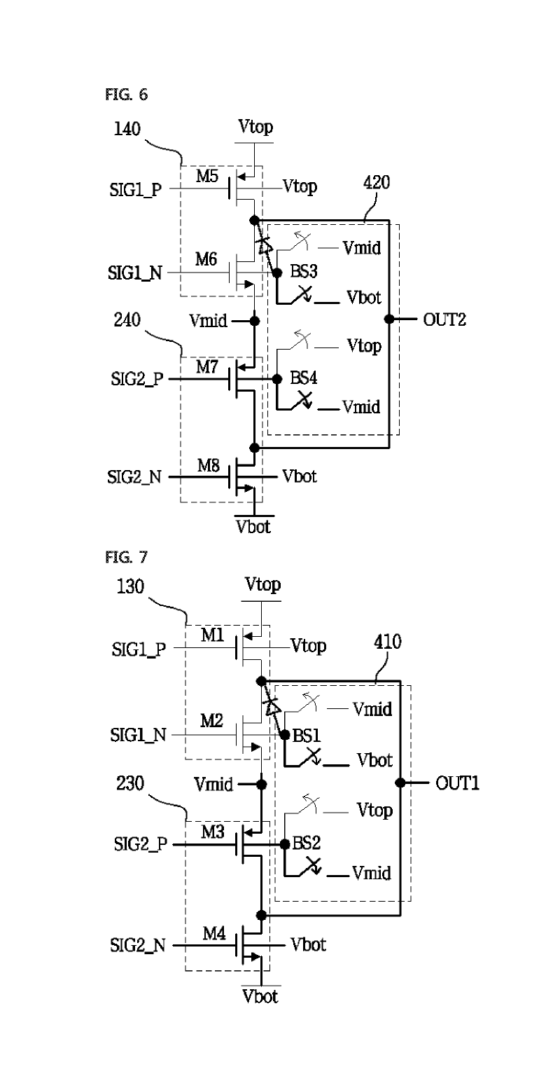

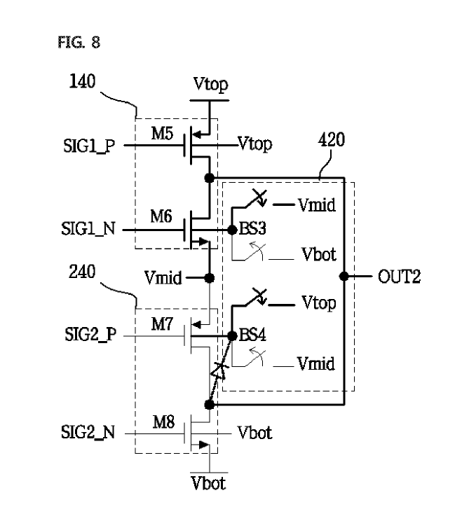

FIG. 5 is a circuit diagram illustrating a part of an output circuit of a display driving device according to another embodiment of the present invention. FIG. 6 is a circuit diagram illustrating the other part of the output circuit of the display driving device according to the embodiment of the present invention. FIG. 7 is a circuit diagram illustrating a state in which a signal transmission path different from FIG. 5 is formed. FIG. 8 is a circuit diagram illustrating a state in which a signal transmission path different from FIG. 7 is formed.

In FIGS. 5 to 8, an illustration of the bias units 110 and 210 and the control switches CS1 to CS4 is omitted, and body control units 410 and 420 are added, compared to FIGS. 2 and 3. The body control units 410 and 420 are configured to change the body voltages of the MOS transistors of the output units 130, 230, 140 and 240 which are not driven in response to a direct path or cross path of the control switches CS1 to CS4. Therefore, the descriptions of the functions of the same components as those of FIGS. 2 and 3 among the components of FIGS. 5 to 8 are omitted herein.

The body control unit 410 may include components for controlling the body voltages of the transistors M2 and M3 among the MOS transistors included in the output units 130 and 130.

More specifically, the body control unit 410 may include a body control switch BS1 for controlling the body voltage of the NMOS transistor M2 of the output unit 130 and a body control switch BS2 for controlling the body voltage of the PMOS transistor M3 of the output unit 230.

The body control unit 410 controls the body voltages of the MOS transistors M2 and M3 in order to prevent a current leakage by a formation of parasitic diode.

The body control unit 420 may include a body control switch BS3 for controlling the body voltage of the NMOS transistor M6 of the output unit 140 and a body control switch BS4 for controlling the body voltage of the PMOS transistor M7 of the output unit 240.

The body control unit 420 controls the body voltages of the MOS transistors M5 and M6 in order to prevent a current leakage caused by a formation of parasitic diode.

Referring to FIG. 5, when the control switches CS1 to CS4 form a direct path, the body control unit 410 is operated as follows. When the driving signals SIG1_P and SIG1_N are provided to the PMOS transistor M1 and the NMOS transistor M2 of the output unit 130 from the bias unit 110, the PMOS transistor M1 and the NMOS transistor M2 are driven. At this time, the voltage applied to the drain of the PMOS transistor M3 of the output unit 230 which is not driven may form a parasitic diode between the drain and body of the PMOS transistor M3.

In order to prevent the formation of a parasitic diode, the body control switch BS2 switches the voltage applied to the body of the PMOS transistor M3 from the third voltage Vmid to the first voltage Vtop in response to an external body voltage control signal. Furthermore, the body control switch BS1 switches the voltage applied to the body of the NMOS transistor M2 from the second voltage Vbot to the third voltage Vmid, for a smooth switching operation of the NMOS transistor M2.

That is, the body control unit 410 may change the body voltage of the NMOS transistor M2 of the output unit 130 or the PMOS transistor M3 of the output unit 230 to any one of the first to third voltages Vtop, Vmid and Vbot, and the body control unit 420 may change the body voltage of the NMOS transistor M6 of the output unit 140 or the PMOS transistor M7 of the output unit 240 to any one of the first to third voltages Vtop, Vmid and Vbot.

Referring to FIG. 6, when the control switches CS1 to CS4 form a direct path, the body control unit 420 is operated as follows. When the driving signals SIG2_P and SIG2_N are provided to the PMOS transistor M7 and the NMOS transistor M8 of the output unit 240 from the bias unit 210, the PMOS transistor M7 and the NMOS transistor M8 are driven. At this time, the voltage applied to the drain of the NMOS transistor M6 of the output unit 140 which is not driven may form a parasitic diode between the drain and body of the NMOS transistor M6.

In order to prevent the formation of a parasitic diode, the body control switch BS3 switches the voltage applied to the body of the NMOS transistor M6 from the third voltage Vmid to the second voltage Vbot in response to an external body voltage control signal. Furthermore, the body control switch BS4 switches the voltage applied to the body of the PMOS transistor M7 from the first voltage Vtop to the third voltage Vmid, for a smooth switching operation of the PMOS transistor M7.

FIG. 7 illustrates an operation of the body control unit 410 when the control switches CS1 to CS4 form a cross path. When the driving signals SIG2_P and SIG2_N are provided to the PMOS transistor M3 and the NMOS transistor M4 of the output unit 230 from the bias unit 210, the PMOS transistor M3 and the NMOS transistor M4 are driven. At this time, the voltage applied to the drain of the NMOS transistor M2 of the output unit 130 which is not driven may form a parasitic diode between the drain and body of the NMOS transistor M2.

In order to prevent the formation of a parasitic diode, the body control switch BS1 switches the voltage applied to the body of the NMOS transistor M2 from the third voltage Vmid to the second voltage Vbot in response to the external body voltage control signal. Furthermore, the body control switch BS2 switches the voltage applied to the body of the PMOS transistor M3 from the first voltage Vtop to the third voltage Vmid, for a smooth switching operation of the PMOS transistor M3.

FIG. 8 illustrates an operation of the body control unit 420 when the control switches CS1 to CS4 form a cross path. When the driving signals SIG1_P and SIG1_N are provided to the PMOS transistor M5 and the NMOS transistor M6 of the output unit 140 from the bias unit 110, the PMOS transistor M5 and the NMOS transistor M6 are driven. At this time, the voltage applied to the drain of the PMOS transistor M7 of the output unit 240 which is not driven may form a parasitic diode between the drain and body of the PMOS transistor M7.

In order to prevent the formation of a parasitic diode, the body control switch BS4 switches the voltage applied to the body of the PMOS transistor M7 from the third voltage Vmid to the first voltage Vtop in response to the external body voltage control signal. Furthermore, the body control switch BS3 switches the voltage applied to the body of the NMOS transistor M6 from the second voltage Vbot to the third voltage Vmid, for a smooth switching operation of the NMOS transistor M6.

The points of time that the body voltage control signal is provided to the body control switches BS1 to BS4 in order to control the body voltages of the MOS transistors M2, M3, M6 and M7 may be included in a source output enable (SOE) period or a vertical blank period of the display driving device.

As described above, the output circuit of the display driving device according to the present embodiment can perform switching for polarity reversal in an output buffer, thereby preventing heat generation and waveform delay between the output buffer and the output terminal.

Furthermore, the output circuit of the display driving device can prevent a formation of parasitic diode between the transistors installed in the output units of the output buffer, thereby smoothing the operation of the output buffer.

While various embodiments have been described above, it will be understood to those skilled in the art that the embodiments described are by way of example only. Accordingly, the disclosure described herein should not be limited based on the described embodiments.

What is claimed is:

1. An output circuit of a display driving device, comprising:
a first buffer configured to provide a first input signal of an internal voltage domain as any one of first and second output signals to a display panel through a first internal switching operation corresponding to polarity reversal, and comprising a first output unit configured to provide the first output signal and a third output unit configured to provide the second output signal, wherein the first and third output units are driven in a range of a positive output signal included in an output voltage domain corresponding to the display panel;
a second buffer configured to provide a second input signal of the internal voltage domain as the other one of the first and second output signals to the display panel through a second internal switching operation corresponding to the polarity reversal, and comprising a second output unit configured to provide the first output signal and a fourth output unit configured to provide the second output signal, wherein the second and fourth output units are driven in a range of a negative output signal included in the output voltage domain corresponding to the display panel;
a first body control unit configured to control a body voltage of a pull-down driving element of the first output unit or a pull-up driving element of the second output unit; and
a second body control unit configured to control a body voltage of a pull-down driving element of the third output unit or a pull-up driving element of the fourth output unit.

2. The output circuit of claim 1, wherein the first buffer further comprises a first bias unit configured to provide a first driving signal in response to the first input signal, the first output unit provides the first output signal in response to the first driving signal, and the third output unit provides the second output signal in response to the first driving signal,
wherein the second buffer further comprises a second bias unit configured to provide a second driving signal in response to the second input signal, the second output unit provides the first output signal in response to the second driving signal, and the fourth output unit provides the second output signal in response to the second driving signal.

3. The output circuit of claim 1, wherein the first and second body control units control the body voltage of the pull-down or pull-up driving element which is not driven.

4. The output circuit of claim 1, wherein the first and second body control units control the body voltage in response to one or more of a source output enable (SOE) period and a vertical blank period of the display driving device.

5. The output circuit of claim 1, wherein the pull-down driving elements of the first and third output units are NMOS transistors, and the pull-up driving elements of the second and fourth output units are PMOS transistors.

6. The output circuit of claim 1, wherein the output voltage domain is defined by the highest first voltage and the lowest second voltage,
a third voltage is defined by an average of the first and second voltages,
the range of the positive output signal is defined between the first voltage and the third voltage,
the range of the negative output signal is defined between the third voltage and the second voltage, and
the output voltage domain is set to a wider range than the internal voltage domain.

7. The output circuit of claim 6, wherein the first body control unit changes the body voltage of the pull-down driving element of the first output unit or the pull-up driving element of the second output unit to any one of the first to third voltages, and
the second body control unit changes the body voltage of the pull-down driving element of the third output unit or the pull-up driving element of the fourth output unit to any one of the first to third voltages.

8. The output circuit of claim 6, wherein the first body control unit comprises a first body control switch configured to control the body voltage of the pull-down driving element of the first output unit and a second body control switch configured to control the body voltage of the pull-up driving element of the second output unit, and
the second body control unit comprises a third body control switch configured to control the body voltage of the pull-down driving element of the third output unit and a fourth body control switch configured to control the body voltage of the pull-up driving element of the fourth output unit.

9. The output circuit of claim 8, wherein the first body control switch controls an application of the second or third voltage to the body of the pull-down driving element of the first output unit,
the second body control switch controls an application the first or third voltage to the body of the pull-up driving element of the second output unit,
the third body control switch controls an application the second or third voltage to the body of the pull-down driving element of the third output unit, and
the fourth body control switch controls an application the first or third voltage to the body of the pull-up driving element of the fourth output unit.

10. The output circuit of claim 8, wherein the first to fourth body control switches control a voltage applied to the body voltage in response to a body voltage control signal provided at one or more of a source output enable (SOE) period and a vertical blank of the display driving device.

11. The output circuit of claim 1, wherein the first buffer further comprises a first feedback switch configured to feed back any one of the first and second output signals, and
the second buffer further comprises a second feedback switch configured to feed back the other one of the first and second output signals.

12. The output circuit of claim 1, wherein the first buffer comprises: a first control switch configured to form a first signal transmission path for outputting the first output signal in response to the first input signal; and a third control switch configured to form a third signal transmission path for outputting the second output signal in response to the first input signal, in order to perform the first internal switching operation, and
the second buffer comprises: a second control switch configured to form a second signal transmission path for outputting the first output signal in response to the second input signal; and a fourth control switch configured to form a fourth signal transmission path for outputting the second output signal in response to the second input signal, in order to perform the second internal switching operation.

13. The output circuit of claim 12, wherein the first to fourth control switches selectively form the first to fourth signal transmission paths in response to a polarity reversal signal for the polarity reversal.

14. The output circuit of claim 13, wherein the first to fourth control switches form a direct path or cross path,
wherein the direct path is formed by the first and fourth control switches which are turned on, and the cross path is formed by the second and third control switches which are turned on.
